(19) United States
(12) Patent Application Publication
(10) Pub. No.: US 2020/0005135 A1
(43) Pub. Date: Jan. 2, 2020

(54) OPTIMIZING INFERENCE FOR DEEP-LEARNING NEURAL NETWORKS IN A HETEROGENEOUS SYSTEM

(71) Applicant: Advanced Micro Devices, Inc., Santa Clara, CA (US)

(72) Inventor: Shuai Che, Kirkland, WA (US)

(73) Assignee: Advanced Micro Devices, Inc., Santa Clara, CA (US)

(21) Appl. No.: 16/023,638

(22) Filed: Jun. 29, 2018

(51) Int. Cl. G06N 3/08; G06N 3/04; G06N 3/063

(52) U.S. Cl. CPC G06N 3/08; G06N 3/063; G06N 3/04

(57) ABSTRACT

Systems, methods, and devices for deploying an artificial neural network (ANN). Candidate ANNs are generated for performing an inference task based on specifications of a target inference device. Trained ANNs are generated by training the candidate ANNs to perform the inference task on an inference device conforming to the specifications. Characteristics describing the trained ANNs performance of the inference task on a device conforming to the specifications are determined. Profiles that reflect the characteristics of each trained ANN are stored. The stored profiles are queried based on requirements of an application to select an ANN from among the trained ANNs. The selected ANN is deployed on an inference device conforming to the target inference device specifications. Input data is communicated to the deployed ANN from the application. An output is generated using the deployed ANN, and the output is communicated to the application.

### BACKGROUND

In the future, various computer systems will become increasingly heterogeneous. Heterogeneous systems can include different types of processing units, such as central processing units (CPU), graphics processing units (GPU), accelerated processing units (APU) and the like. The various processing units can be discrete, be located on the same die, or located on one or more processor cores, wherein each processor core is a CPU or a GPU. The processing units can be located within the same device or on different devices or nodes of a distributed system. Heterogeneous systems can also include different layers of memory, such as cache memory, main memory, and device memory. The different layers of memory can also include different types of memory, such as processing-in-memory (PIM) devices, die-stacked memory, non-volatile storage, and so forth. The different layers and types of memory can be located on different devices or nodes of a distributed system.

It may be desired to provide artificial neural networks (ANN) configured to take advantage of the heterogeneous processors and/or heterogeneous memories of such architectures.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a block diagram illustrating an example device in which one or more features of the disclosure can be implemented;

FIG. 4 is a block diagram illustrating example artificial neural network (ANN) configurations with which one or more features of the disclosure can be implemented;

FIG. 5 is a flow chart illustrating an example method by which one or more features of the disclosure can be implemented;

FIG. 6 is a block diagram illustrating an application of an example ANN to the example device of FIG. 3;

FIG. 7 is a block diagram illustrating another application of an example ANN to the example device of FIG. 3;

FIG. 8 is a block diagram illustrating another application of an example ANN to the example device of FIG. 3;

FIG. 9 is a block diagram illustrating another application of an example ANN to the example device of FIG. 3;

FIG. 10 is a flow chart illustrating an example method for generating and deploying an ANN to perform an inference task; and

FIG. 11 is a block diagram illustrating an example system for generating and deploying ANNs.

### DETAILED DESCRIPTION

The present disclosure provides systems, methods, and devices for deploying an artificial neural network (ANN). In some alternatives, candidate ANNs are generated for performing an inference task based on specifications of a target inference device. Trained ANNs are generated by training the candidate ANNs to perform the inference task on an inference device conforming to the specifications. Characteristics describing the trained ANNs performance of the inference task on a device conforming to the specifications are determined. Profiles of the trained ANNs are stored. The profiles reflect the characteristics of each trained ANN. The stored profiles are queried based on requirements of an application to select an ANN from among the trained ANNs. The selected ANN is deployed on an inference device conforming to the target inference device specifications. Input data is communicated to the deployed ANN from the application. An output is generated using the deployed ANN, and the output is communicated to the application. In some implementations, the profiles are stored in a database, and the database is queried based on the requirements.

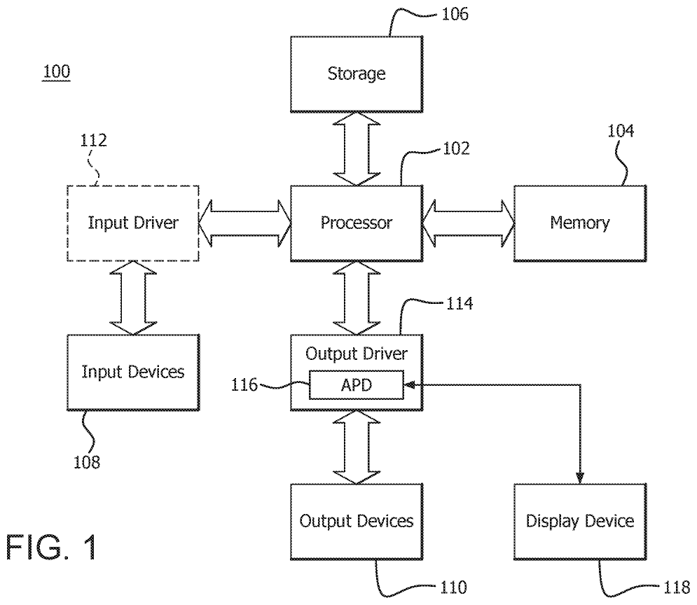

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection, for example, a wireless local area network card for transmission and/or reception of wireless IEEE 802 signals. The output devices 110 include, without limitation, a display, a speaker, a printer, a haptic feedback device, one or more lights, an antenna, or a network connection, for example, a wireless local area network card for transmission and/or reception of wireless IEEE 802 signals.

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD is configured to accept compute commands and graphics rendering commands from processor 102, to process those compute and graphics rendering commands, and to provide pixel output to display device 118 for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor for example, processor 102, and configured to provide graphical output to a display device 118. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm performs the functionality described herein.

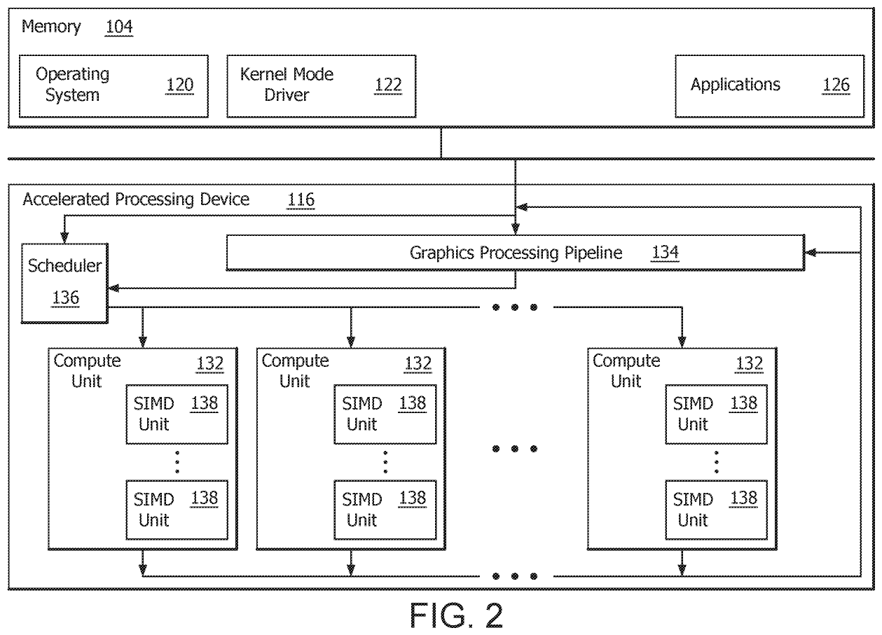

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software for example, applications 126, executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 is configured to perform operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134, for example, custom operations performed to supplement processing performed for operation of the graphics pipeline 134. An application 126 or other software executing on the processor 102 transmits programs that define such computation tasks to the APD 116 for execution.

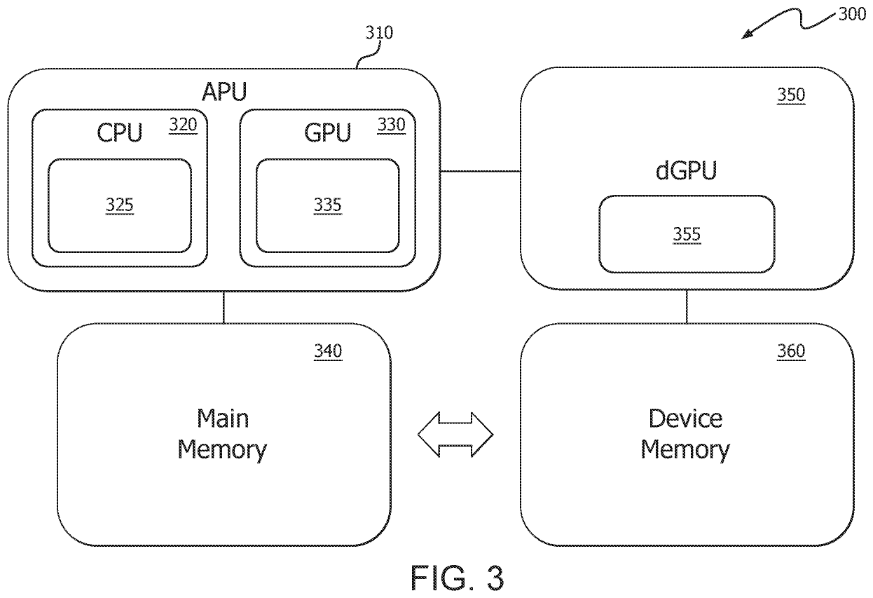

FIG. 3 is a block diagram illustrating an example device 300 in which one or more features of the disclosure can be implemented. Device 300 includes an accelerated processing unit (APU) 310, main memory 340, discrete graphics processing unit (dGPU) 350, and device memory 360. In some alternatives, device 300 is implemented using components of device 100 as shown and described with respect to FIGS. 1 and 2. In some alternatives, device 300 includes a greater or lesser number of components. For example, in some alternatives, APU 310 is omitted from device 300, which instead includes a discrete CPU (not shown). In another example, device memory 360 is omitted from device 300, and dGPU 350 instead uses main memory 340. In other examples, device 300 omits dGPU 350 and device memory 360, or includes additional dGPUs, which share device memory 360 or instead use main memory 340 or a separate device memory. In still other examples, device 300 includes dedicated processing circuitry, application specific integrated circuits (ASICs) or field programmable gate arrays (FPGAs) which include caches, memories, and/or can share and/or be in communication with the other components of device 300. Various suitable arrangements and permutations of device 300 usable in various alternatives are evident, and for brevity, are not described in further detail.

APU 310 includes a CPU 320 and a GPU 330. In some alternatives, APU 310 is implemented using APD 116 as shown and described with respect to FIGS. 1 and 2, and/or using another suitable APD device. In other alternatives, CPU 320 and GPU 330 are implemented as separate devices, for example, not as part of the same APU 310. Any suitable arrangement of APU 310, CPU 320, and/or GPU 330 can be used in various alternatives.

CPU 320, in some alternatives, is implemented using one or more compute units of APU 310. For example, CPU 320 can be implemented using one or more compute units 132 and/or other suitable components of APD 116 as shown and described with respect to FIG. 2. CPU 320 can also, or instead, be implemented using different types of compute units (not shown) of APD 116, and/or other compute units suitable for graphics processing, general purpose processing, or other tasks, for example, using a compute unit that does not correspond to a SIMD paradigm, such as an x86 or ARM core. CPU 320 can include local memory, such as a cache 325. In some alternatives, cache 325 includes one or more levels of cache memory. In some alternatives, CPU 320 can also or alternatively access a local memory of APU 310, such as an APU cache.

GPU 330 can include any suitable graphics processing hardware. For example, in some alternatives, GPU 330 is implemented using one or more compute units 132 and/or other suitable components of APD 116 as shown and described with respect to FIG. 2. In some alternatives, GPU 330 includes one or more parallel processing units to perform computations in accordance with a SIMD paradigm. GPU 330 can also, or instead, be implemented using different types of compute units (not shown) of APD 116, or other compute units suitable for graphics processing, general purpose processing, or other tasks. GPU 330 can include local memory, such as a cache 335. In some alternatives, cache 335 includes one or more levels of cache memory. In some alternatives, GPU 330 can also or alternatively access a local memory of APU 310, such as an APU cache.

APU 310 (including CPU 320 and GPU 330) is in communication with main memory 340 and dGPU 350. In some alternatives, such communication is effected using a system bus or another suitable computer communications medium. Main memory 340 can include any non-transitory computer readable medium, or combination of such media. In some alternatives, main memory 340 includes a dynamic random-access memory (DRAM) such as a 3-D stacked DRAM.

dGPU 350 can include any suitable graphics processing hardware that is discrete from APU 310. For example, in some alternatives, dGPU 350 is implemented using one or more devices similar to compute units 132 and/or other suitable components of APD 116 as shown and described with respect to FIG. 2. In some alternatives, dGPU 350 includes one or more parallel processing units configured to perform computations in accordance with a SIMD paradigm. dGPU 350 can also, or instead, be implemented using different types of compute units (not shown) or other compute units suitable for graphics processing, general purpose processing, or other tasks. dGPU 350 can include local memory, such as a cache 355. In some alternatives, cache 355 includes one or more levels of cache memory. dGPU 350 is also in communication with device memory 360. Device memory 360 can include any non-transitory computer readable medium, or combination of such media. In some alternatives, main memory 340 includes a dynamic random-access memory (DRAM) such as a 3-D stacked DRAM.

Information can be transferred among the components of device 300 in any suitable way. For example, in some alternatives, information can be transferred between main memory 340 and device memory 360 by APU 310 using direct memory access (DMA). Similarly, information can be transferred from device memory 360 to main memory 340 by dGPU 350 using DMA. It is noted that in some alternatives, any suitable memory transfer protocol or method can be used. In some alternatives, information can be transferred among some or all of the various memory devices of device 300, for example, cache 325, cache 335, cache 355, main memory 340, and device memory 360. Information transfers can be made between any other suitable memory devices. Further, memory and data structures can be shared between or among any suitable devices. For example, in some alternatives, CPU 320 and GPU 330 share data structures in a single, unified memory space.

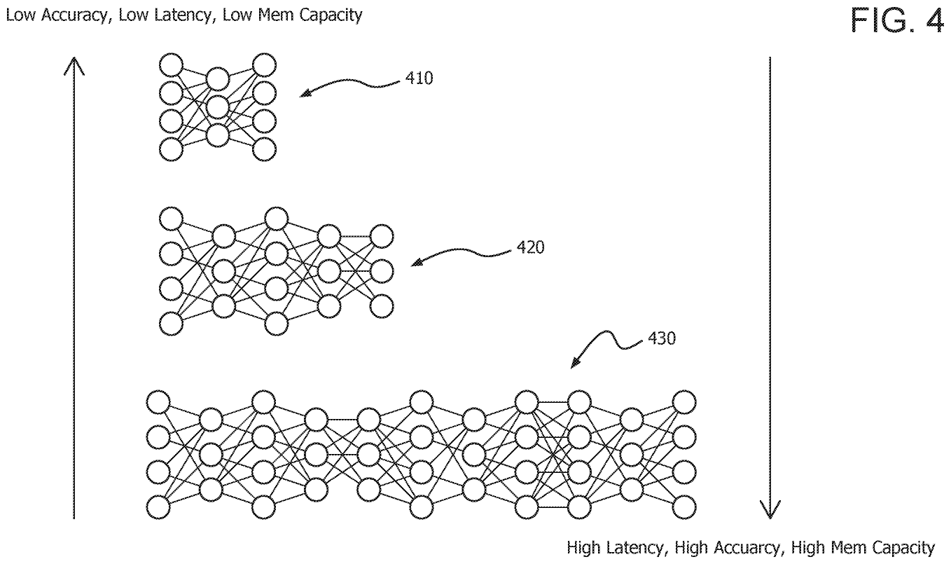

FIG. 4 is a block diagram illustrating several example ANNs with which one or more features of the disclosure can be implemented. An ANN is a computing device or system inspired by the way biological nervous systems, such as brains, process information. An ANN includes an interconnected group of nodes. The nodes of an ANN can be referred to as artificial neurons. The nodes are interconnected by links. Each node receives input data, performs operations on the data, and passes the results on to other nodes. The output of a node can be referred to as its activation, or node value. Each of the links is associated with a weight. The ANN is trained by inputting a training data set, having a known correct output, to generate an output inference. The output inference is compared to the known correct input, and the difference, if any, is used to adjust the weights. This procedure is performed iteratively to converge on an optimized weighting for the ANN based on that training data set. In some alternatives, both training of and inference by ANNs begins with the same forward propagation calculation, however, the training phase also includes a backpropagation calculation. Backpropagation can be accomplished through a series of matrix manipulations, for example, convolutions.

ANN 410 is a fully connected neural network having an input layer, output layer, and one hidden layer. ANN 420 is a fully connected neural network having an input layer, output layer, and three hidden layers. ANN 430 is a fully connected neural network having an input layer, output layer, and 9 hidden layers.

In each example ANN 410, 420, 430, the input, output, and hidden layers are interconnected by various links as shown in FIG. 4. In these examples, each node shares a link with each node in its logically adjacent layers. This topology is only one example, and it is noted that an ANN can be arranged in any suitable topology. In some examples, an ANN instead includes a different number of hidden layers, different numbers of input and/or output nodes, and/or different numbers and/or arrangements of links. It is noted that in other ANNs, each node need not share a link with each node in its logically adjacent layers. ANNs 410, 420, and 430 are shown as fully connected (multi-layer perceptron) neural networks for the sake of example, however it is noted that the techniques discussed herein can be applied to any other suitable ANN, such as a convolutional neural network (CNN), recurrent neural network (RNN), or any combination of these or other types of ANNs.

In each ANN 410, 420, 430, each of the hidden nodes receives data from one or more preceding nodes in a logically adjacent layer via a link, and outputs data to one or more succeeding nodes in a logically adjacent layer via a link. In this context, a preceding node is closer to the input layer, and a succeeding node is closer to the output layer. Each node processes its input data according to a function, which can be referred to as an activation function of the node. Each of the links is associated with a weight by which the data passing over that link is weighted before it is input to the activation function. In some alternatives, the link is weighted by a multiplication factor, for example.

Hidden nodes process the data input from input nodes, as weighted by the corresponding link weights, according to their activation functions, to generate output data. This output data from the hidden node is in turn input by output nodes, as weighted by the link weights associated with the corresponding links. Based on the activation functions of each of the nodes and the link weights of each of the links, an output is generated at the output nodes based on data input to input nodes.

ANNs 420 and 430 can be referred to as deep neural networks (DNN) (or deeper neural networks) due to their number of hidden layers. ANNs 410, 420, 430 are each configured to perform the same inference task. In an inference task, a prediction is generated as an output of the ANN based on a specified input and using a trained model. In one alternative, ANNs 410, 420, 430 are each configured to output an identification (or possible identification) of a tumor based on an input of data representing a computed tomography (CT) scan of a patient. This example inference task is used for the sake of example only. ANNs 410, 420, 430 could be configured with other inference tasks. Examples of inference tasks include but are not limited to image recognition, speech recognition, text recognition, self-driving vehicle applications, and so forth.

In the example of FIG. 4, ANN 410 is capable of generating an inference in less time than ANNs 420, 430, on the same hardware and given the same or similar input data. ANN 410 also has a lower memory capacity requirement than ANNs 420, 430. In other words, the parameters, weights, data structures, or other information defining ANN 410 require less memory space to store and operate. On the other hand, in this example, an inference generated by ANN 410 will be less accurate than an inference generated by ANNs 420, 430 on the same hardware and given the same or similar input data. Accuracy, in the examples herein, refers to a percentage of correct inferences based on a given input, or a percentage of inferences which match expected inferences based on an input training or test set, for example.

In the example of FIG. 4, ANN 410 has lower latency and has a lower memory capacity requirement, but is less accurate than ANNs 420 and 430, because it has fewer hidden layers and interconnections. It is noted that in other cases, an ANN has lower latency, has a lower memory capacity requirement, and is less accurate than other ANNs capable of generating the same or a similar inference, given the same or similar input data, for other reasons. For example, in some alternatives, instead of (or in addition to) altering the number of layers, the number of neurons in a layer is increased relative to other ANNs. In some alternatives, this increases accuracy at the cost of memory capacity and/or latency, and vice versa. In another example, instead of (or in addition to) altering the number of layers, different types of layers for example, convolution layers, recurrent layers, and the like, and/or different types of activation functions are used to obtain different tradeoffs among accuracy, memory capacity, and latency. Various combinations of these approaches are used in various alternatives. In some examples, ANN 410 is advantageous over ANN 420 and ANN 430 in cases where it is desired to provide a faster inference, if the accuracy of the inference still falls within an acceptable or given threshold. It is assumed in the examples herein that the relative inference time and accuracy among ANNs 410, 420, and 430 is with respect to the same hardware, for example, device 300. It is noted however that if ANNs 410, 420, and 430 are executed on different devices having different capabilities, in some cases, the relative end-to-end latency differs. In some examples, relative end-to-end latency does not directly correspond to the number of layers.

ANN 430 will take more time to generate an inference than ANNs 410, 420 on the same hardware and given the same or similar input data. ANN 430 also has a higher memory capacity requirement than ANNs 410, 420—that is to say, the parameters, weights, activation functions, data structures, and other information defining ANN 430 require more memory space to store and operate. On the other hand, an inference generated by ANN 430 can be more accurate than an inference generated by ANNs 410, 420 on the same hardware and given the same or similar input data. In the case of the examples of FIG. 4, ANN 430 has a higher latency and a higher memory capacity requirement, but is more accurate than ANNs 420 and 410, because it has a greater number of hidden layers and interconnections. It is noted that in other cases, an ANN has higher latency and a higher memory capacity requirement, but is less accurate than other ANNs capable of generating the same or a similar inference, given the same or similar input data, for other reasons. In some cases, ANN 430 is advantageous over ANN 420 and ANN 410 in cases where it is desired to provide a more accurate inference. For example, in some cases where the speed of the inference due to the latency of ANN 430 still falls within an acceptable or given threshold, ANN 430 is advantageous over ANN 420 and ANN 410 due to its increased accuracy.

ANN 420 is capable of generating an inference in less time than ANN 430, but more time than ANN 410 on the same hardware and given the same or similar input data. ANN 420 also has a lower memory capacity requirement than ANN 430, but a higher memory capacity requirement than ANN 410—i.e., the parameters, weights, activation functions, data structures, and other information defining ANN 420 require less memory space to store and operate than ANN 430, but more than ANN 410. On the other hand, an inference generated by ANN 420 is less accurate than an inference generated by ANN 430, but more accurate than an inference generated by ANN 410 on the same hardware and given the same or similar input data. In the case of the examples of FIG. 4, ANN 420 has a lower latency and a lower memory capacity requirement, but is less accurate than ANN 430, because it has fewer hidden layers and interconnections. It is noted that in other cases, an ANN is faster or slower, has a lower or higher memory capacity requirement, and/or is more or less accurate than other ANNs capable of generating the same or a similar inference, given the same or similar input data, for other reasons. ANN 420 is advantageous over ANN 410 and ANN 430 in cases where it is desired to provide a faster inference, than ANN 430 for example, where the accuracy of the inference still falls within an acceptable or given threshold and it is also desired to provide a more accurate inference, than ANN 410 for example, where the speed of the inference still falls within an acceptable or given threshold.

In some alternatives, aside from latency and accuracy concerns, ANN 410, 420, or 430 are selected based upon the underlying architecture of the device with which they are implemented. In some examples, ANN 410 is selected for use where the memory structures of the underlying device do not have the capacity to implement ANN 420 or ANN 430, or cannot do so with a speed of inference which falls within an acceptable or given threshold. ANN 430 is selected for use where the memory structures of the underlying device do have the capacity to implement it at an acceptable speed of inference and accuracy, and/or where ANN 410 or 420 cannot be implemented on the underlying device such that the accuracy of inference falls within an acceptable or given threshold.

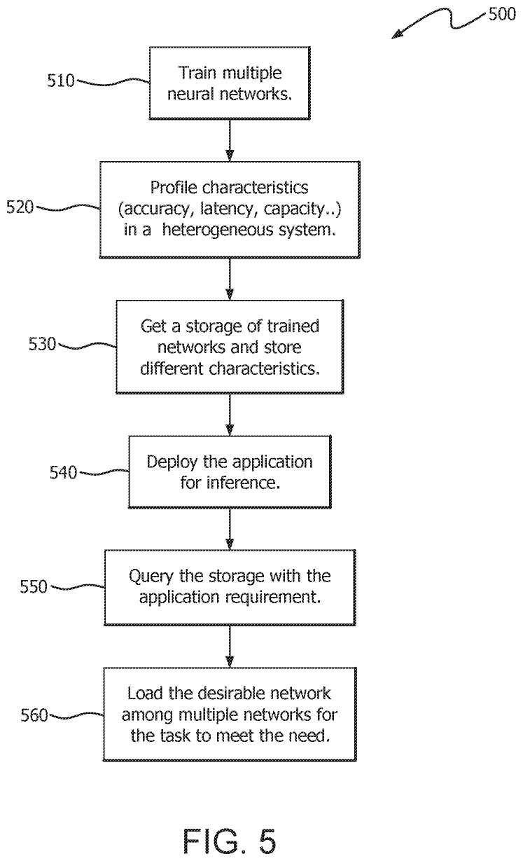

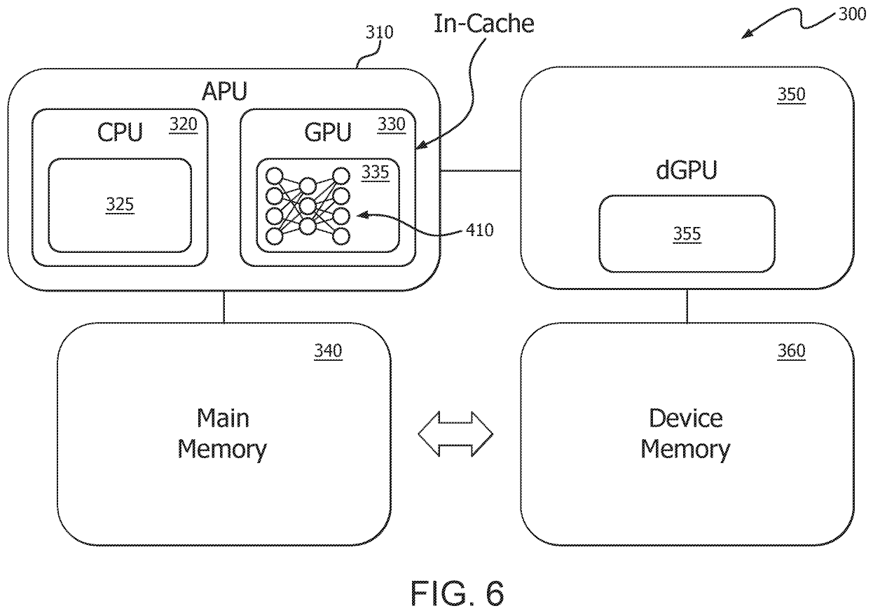

FIG. 5 is a flowchart illustrating an example method 500 for training and employing ANNs. In step 505, information regarding the structure of the target inference device upon which the ANN will be deployed to perform the inference task is input to an analysis device to generate several candidate ANNs. In some examples herein, the inference device is device 300 as shown and described with respect to FIG. 3. The candidate ANNs differ, for example, in terms of their sizes, widths, depths, or other parameters, in order to fit different deployment scenarios, for example, such as FIGS. 6, 7, and 8 as further discussed herein. In different alternatives, the analysis device is the same device or type of device that is used to train the ANNs, or a different device or type of device.

In step 510, each of a plurality of ANNs is trained to perform a particular inference task. For purposes of this example, ANNs 410, 420, and 430, shown and described with respect to FIG. 4, are considered as the plurality of neural networks. In various alternatives, different numbers and/or types of neural networks, for example, fully connected, convolutional, etc., are trained.

Each candidate ANN is trained using one or more devices. In some alternatives, the device is separate from the inference device (i.e., the device on which the ANNs will be deployed to perform the particular inference task), and employs one or more GPU servers to train each ANN using one or more training sets having known output inferences, and/or using any suitable training paradigm, such as backpropagation, to adjust the ANN weighting and/or activation functions.

In step 520, the characteristics of each ANN are determined with respect to the target inference device, for example, by running the ANNs on the system and profiling various characteristics. In this example, the characteristics of each ANN include accuracy of inference, latency, multi-task throughput, power consumption, and memory capacity requirements for performing the particular inference task to generate an inference. In various alternatives, some or all of these characteristics, and/or different suitable characteristics, are determined as desired.

In this example, device 300, shown and described with respect to FIG. 3, is considered as the heterogeneous system, and each of ANNs 410, 420, and 430 are analyzed to determine a profile of their characteristics when installed on device 300 to perform the particular inference task. In an example application, each of ANNs 410, 420, and 430 are analyzed to determine how accurately a tumor diagnosis can be inferred from CT image data input to the neural network, the latency of the neural network in generating this inference, and the memory capacity required for the ANN to perform the inference.

It is noted that in some alternatives, the inference, latency, power, and other characteristics of each ANN can be determined with respect to various different memory and computational configurations of the same heterogeneous device. For example, ANN 410 can have different latency characteristics when installed in cache 325 and executed by CPU 320 as opposed to when installed in cache 335 and executed by GPU 330. In some alternatives, for a given ANN, all of the possible memory configurations and/or computational configurations of the heterogeneous target inference device that are usable with each ANN are profiled, or a subset of the possible configurations are profiled.

In step 530, the determined characteristics of each of the neural networks with respect to the target inference device are stored. In this example, the latency and other characteristics of each of neural networks 410, 420, 430, with respect to performing the example tumor diagnosis inference task on device 300, are stored. In some implementations, the characteristics are stored in a database.

In step 540, an application requiring the particular inference is deployed using the heterogeneous system. In this example, a tumor diagnosis application is executed using device 300. The application has certain requirements, which in this example include an accuracy requirement, and a latency requirement.

In step 550, the determined characteristics of each of the neural networks are queried based on the application requirements, and the neural networks having characteristics which fulfil the application requirements are selected. If the characteristics of several different memory and/or computing configurations of the same neural network are stored, those configurations which fulfil the application requirements are selected. If more than one neural network and/or configuration of a neural network fulfils the application requirements, a single one of these is selected. In some alternatives, the neural network and/or configuration having the best performance with respect to one or more characteristics are selected. For example, if latency is not a major concern, or if a user application requires the best possible accuracy, the neural network with highest accuracy can be selected, or a specific neural network is chosen based on the combined factors of user requirement, system load, energy saving, and other factors.

In some alternatives, the stored characteristics are queried based on a desired memory or processing device. In some alternatives, in addition to the latency and accuracy requirements, the application requires that the ANN model is stored in a GPU cache. In one example, an implementation of ANN 410 installed in cache 335 is selected, assuming it meets latency and accuracy requirements, and an implementation of ANN 410 installed in cache 325 is not selected. In various alternatives, different parts of the device architecture of the target inference device are profiled. In some examples, different memories or layers of memory hierarchy of the target device, including die-stacked memory, non-volatile memory, or solid state drive (SSD), are included in the target inference device. All such memories or layers of memory hierarchy impact latency, power, throughput, and other characteristics, and in some alternatives any or all of which are used to generate candidate ANNs, and to profile the generated candidate ANNs.

In some alternatives, method 500 is considered as two separate network creation and deployment methods. In such cases, steps 510, 520, and 530 are considered to be a network creation method, and steps 540, 550, and 560, are considered to be a method of deploying a suitable neural network.

In step 560, the selected neural network is installed on the heterogeneous system, and the application employs the neural network to perform the desired inference. In FIGS. 6-9, several examples of such installations are shown and described.

FIG. 6 is a block diagram illustrating one example scenario where an ANN is deployed or “installed” onto device 300 in order to generate an inference. In this example, ANN 410 is installed within cache 335 of GPU 330. In some alternatives, ANN 410 is installed within cache 335 based on some or all of the method 500 shown and described with respect to FIG. 5. In such alternatives, the characteristics of ANN 410, when installed on cache 335 and run by GPU 330, are determined to meet the requirements of an application executed by device 300. Accordingly, ANN 410 is loaded into cache 335 for use by GPU 330 in performing the inference task required by the application.

Using the example of an application for diagnosing a tumor from CT image data discussed above, stored profiles of ANNs 410, 420, and 430, characterized using various permutations of memory and processing resources of device 300, are queried with the inference and latency requirements of the application. In this case, the inference accuracy and latency are both met (or best met) by ANN 410 when installed on cache 335 and run by GPU 330.

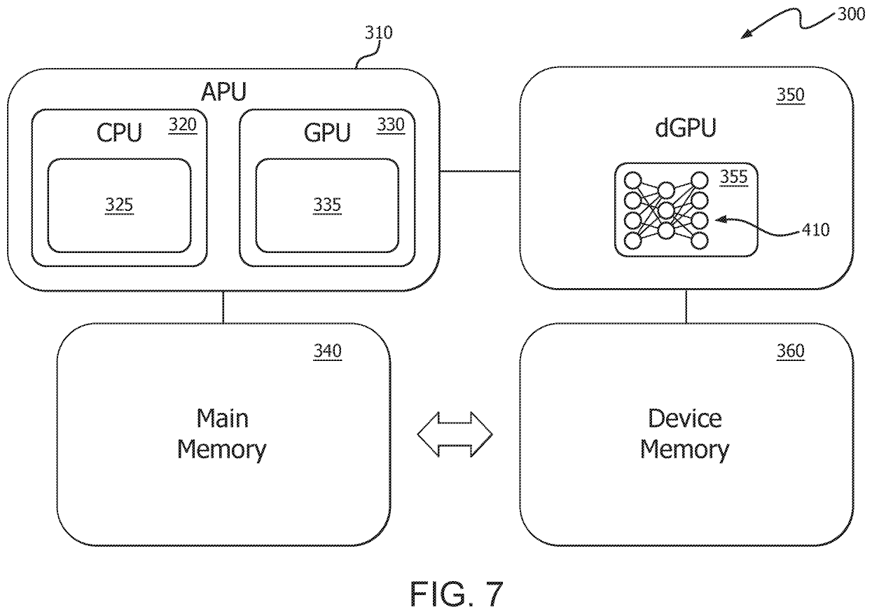

FIG. 7 is a block diagram illustrating another example scenario where an ANN is installed onto device 300 in order to generate an inference. In this example, ANN 410 is installed within cache 355 of dGPU 350. In some alternatives, ANN 410 is installed within cache 355 based on some or all of the method 500 shown and described with respect to FIG. 5. In such alternatives, the characteristics of ANN 410, when installed on cache 355 and run by dGPU 350, are determined to meet the requirements of an application executed by device 300. Accordingly, ANN 410 is loaded into cache 355 for use by dGPU 350 in performing the inference task required by the application.

Using the example of an application for diagnosing a tumor from CT image data discussed above, stored profiles of ANNs 410, 420, and 430, characterized using various permutations of memory and processing resources of device 300, are queried with the inference and latency requirements of the application. In this case, the inference accuracy and latency are both met (or best met) by ANN 410 when installed on cache 355 and run by dGPU 350.

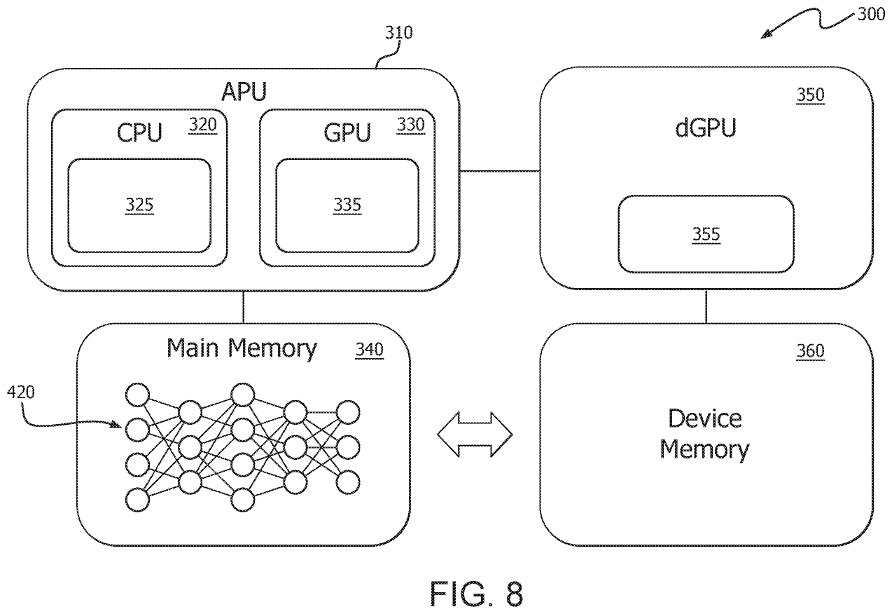

FIG. 8 is a block diagram illustrating one example scenario where an ANN is installed onto device 300 in order to generate an inference. In this example, ANN 420 is installed within main memory 340. In some alternatives, ANN 420 is installed within main memory 340 based on some or all of the method 500 shown and described with respect to FIG. 5. In such alternatives, the characteristics of ANN 420, when installed on main memory 340, are determined to meet the requirements of an application executed by device 300. Accordingly, ANN 420 is loaded into main memory 340 for use in performing the inference task required by the application.

Using the example of an application for diagnosing a tumor from CT image data discussed above, stored profiles of ANNs 410, 420, and 430, characterized using various permutations of memory and processing resources of device 300, are queried with the inference and latency requirements of the application. In this case, the inference accuracy and latency are both met (or best met) by ANN 420 when installed on main memory 340. In this example, a processing resource is not specified by the application, and ANN 420 is executed by either CPU 320 or GPU 335, depending on whether such execution meets the latency and accuracy requirements, and whether the application has a desired processing device requirement.

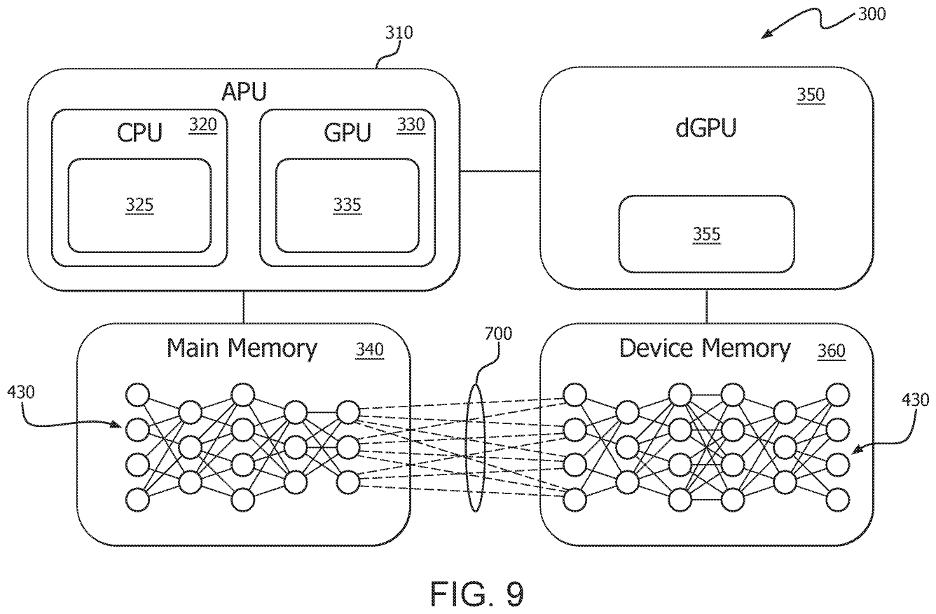

FIG. 9 is a block diagram illustrating another example scenario where an ANN is installed onto device 300 in order to generate an inference. In this example, ANN 430 is installed across both main memory 340 and device memory 360. In some alternatives, ANN 430 is installed across both main memory 340 and device memory 360 based on some or all of the method 500 shown and described with respect to FIG. 5. In such alternatives, the characteristics of ANN 430, when installed across both main memory 340 and device memory 360, are determined to meet the requirements of an application executed by device 300. Accordingly, ANN 430 is loaded into main memory 340 and device memory 360 for use in performing the inference task required by the application. In this example, CPU 320 or GPU 335 process a subset of the layers of ANN 430 and transmit the intermediate data across the interconnect, for example as indicated by links 700, to dGPU 350 for processing of the remaining layers.

Using the example of an application for diagnosing a tumor from CT image data discussed above, stored profiles of ANNs 410, 420, and 430, characterized using various permutations of memory and processing resources of device 300, are queried with the inference and latency requirements of the application. In this case, the inference accuracy and latency are both met (or best met) by ANN 430 when installed across both main memory 340 and device memory 360. In this example, a processing resource is not specified by the application, and ANN 430 is executed by CPU 320, GPU 335, or dGPU 350, depending on whether such execution meets the latency and accuracy requirements, and whether the application has a desired processing device requirement.

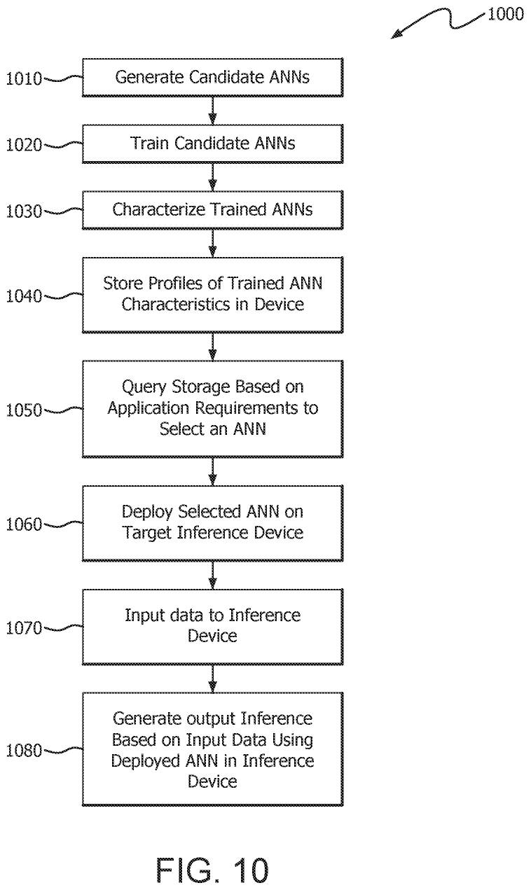

FIG. 10 is a flowchart illustrating an example method 1000 for generating and deploying an ANN to perform an inference task. It is noted that some alternatives include only a subset of the steps of method 1000, or different steps.

In step 1010, an ANN generation device generates at least one candidate ANN based on the specifications of a target inference device. Device 300 (shown and described with respect to FIG. 3) is an example of a target inference device. Example specifications of the target interference device include its architecture, components, bit width, device types, memory structures, memory types, or memory capacity.

In step 1020, the ANN generation device trains the candidate ANNs to perform the inference task on devices conforming to the target inference device specifications. In some alternatives, the candidate ANNs are trained using a separate device. Any suitable ANN training paradigm is used for the training, for example, backpropagation.

In step 1030, the ANN generation device determines characteristics of the trained ANNs at performing the inference task on the target inference device. The characteristics can include, for example, memory capacity requirement, inference time, latency, accuracy, number of layers, type of layer, type of activation, ANN topology, or any other suitable characteristic.

In step 1040, the ANN generation device stores profiles of the trained ANNs. The profiles are stored on a memory of the ANN generation device, or any other suitable storage device. In some implementations, the profiles are is stored on a memory of a target inference device, a device executing an application which utilizes the target inference device, or any other suitable device. In some implementations, the profiles are stored in a database.

In step 1050, a deployment device queries the stored profiles based on requirements of an application in order to select a trained ANN for deployment on a target inference device. The deployment device is the target inference device itself, or another device, for example, executing the application. The requirements of the application include, in various examples, maximum allowable latency of the ANN, maximum inference time, minimum accuracy of the inference, maximum memory capacity used by the ANN, maximum power consumed by the ANN for inference, constraints on how the ANN can be installed on the inference device or any other suitable requirements. In some examples, constraints on how an ANN can be installed on the inference device include that it must be installed in a GPU cache, or must be installed in main memory, and so forth.

In step 1060, the deployment device installs the selected ANN on the target inference device. In step 1070, the application provides input data to the deployed ANN, and in step 1080, the inference device generates an output inference based on the input data using the deployed ANN. It is noted that the example method 1000 is carried out using several devices. Accordingly, it is understood that specific devices implementing various alternatives implement only a subset of method 1000, or implement different steps.

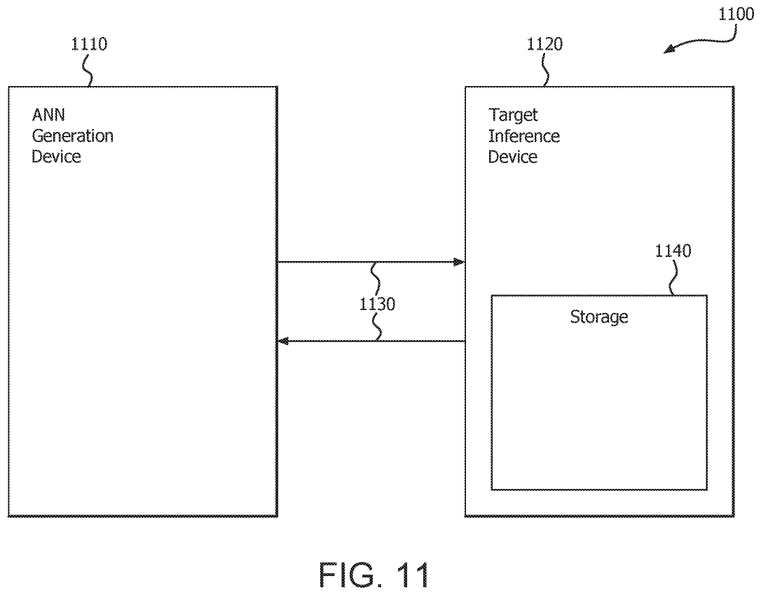

FIG. 11 is a block diagram illustrating an example system 1100 for generating and deploying ANNs. System 1100 is used, for example, to implement method 1000 as shown and described with respect to FIG. 10. System 1100 includes an ANN generation device 1110, target inference device 1120, communications link 1130, and storage 1140. It is understood that in other alternatives, different combinations of devices can be used. In some implementations, storage 1140 includes a database.

ANN generation device 1110 includes any suitable computing device capable of generating, training, or characterizing an ANN, and are used to generate, train, and characterize ANNs as described with respect to method 1000 or otherwise herein. It is noted that in some examples these various tasks are carried out using several devices in communication. ANN generation device 1100 inputs specifications of target inference device 1120 (from target inference device 1120 or from another source) for these purposes. In some implementations, the functions of ANN generation device 1110 and target inference device are implemented using the same device.

Target inference device 1120 includes any suitable computing device capable of loading and running an ANN. One example topology for target inference device 1120 is given by example device 300 shown and described with respect to FIG. 3. Communications link 1130 includes any suitable computer communications medium, and facilitates communication between ANN generation device 1110 and target inference device 1130. Storage 1140 stores profiles of trained ANN characteristics and is queried to select an ANN based on application requirements as described herein. Storage 1140 is shown implemented on target inference device 1120, however it is noted that in other alternatives storage 1140 can be implemented in any suitable location, on or off of target inference device 1120.

A method is provided for deploying an artificial neural network (ANN). The method includes generating candidate ANNs for performing an inference task based on specifications of a target inference device; generating trained ANNs by training the candidate ANNs to perform the inference task on an inference device conforming to the specifications; determining characteristics describing the trained ANNs performance of the inference task on a device conforming to the specifications; storing profiles of the trained ANNs, the profiles reflecting the characteristics of each trained ANN; querying the stored profiles based on requirements of an application to select an ANN from among the trained ANNs; deploying the selected ANN on an inference device conforming to the target inference device specifications.

A method is provided for generating an artificial neural network (ANN). The method includes inputting specifications of a target inference device to an ANN generation device; generating candidate ANNs, by the ANN generation device, based on the specifications; generating trained ANNs, by the ANN generation device, by training the candidate ANNs to perform an inference task; and generating profiles of the trained ANNs. The profiles indicate characteristics of the trained ANNs. The method also includes storing the profiles to be queried based on the requirements and returns a profile of one of the trained ANNs having characteristics satisfying requirements of an application, for deployment on a target inference device.

A method is provided for deploying an artificial neural network (ANN). The method includes querying stored profiles based on requirements of an application to select an ANN. The profiles reflect characteristics of a plurality of ANNs trained to perform an inference task on an inference device conforming to specifications of a target inference device. The method also includes deploying the selected ANN on an inference device conforming to the target inference device specifications.

A device is provided for generating an artificial neural network (ANN). The device includes an input interface to input specifications of a target inference device; processing circuitry to generate candidate ANNs based on the specifications; processing circuitry to generate trained ANNs by training the candidate ANNs to perform an inference task; and profiling circuitry to generate profiles of the trained ANNs which reflect the characteristics of each trained ANN, and to store the profiles to be queried based on the requirements and returns a profile of one of the trained ANNs having characteristics satisfying requirements of an application, for deployment on a target inference device.

A device is provided for deploying an artificial neural network (ANN) to perform an inference task. The device includes an input interface to input inference task requirements of an application, and querying circuitry to query stored profiles based on the requirements. The profiles reflect characteristics of ANNs trained to perform an inference task on a target inference device. The querying circuitry also selects an ANN based on the query. The device also includes deployment circuitry to deploy the selected ANN on an inference device conforming to specifications of the target inference device.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for deploying an artificial neural network (ANN), the method comprising:
generating candidate ANNs for performing an inference task based on specifications of a target inference device;
generating trained ANNs by training the candidate ANNs to perform the inference task on an inference device conforming to the specifications;
determining characteristics describing the trained ANNs performance of the inference task on a device conforming to the specifications;
storing profiles of the trained ANNs, the profiles reflecting the characteristics of each trained ANN;
querying the stored profiles based on requirements of an application to select an ANN from among the trained ANNs;
deploying the selected ANN on an inference device conforming to the target inference device specifications.

2. The method of claim 1, wherein the specifications of the target inference device comprise the architecture, components, bit width, device types, memory structures, memory types, or memory capacity of the target inference device.

3. The method of claim 1, further comprising:
communicating input data to the deployed ANN from the application;
generating an output using the deployed ANN; and
communicating the output data to the application.

4. The method of claim 1, wherein the characteristics of the trained ANNs comprise a memory capacity requirement, inference time, latency, accuracy, number of layers, type of layer, type of activation function, or ANN topology.

5. The method of claim 1, further comprising receiving, in response to querying the stored profiles, an indication of one or more ANNs having a stored profile that satisfies the requirement.

6. The method of claim 1, wherein the application provides data to the deployed ANN and receives an inference from the deployed ANN based on the data.

7. The method of claim 1, wherein the requirements of the application comprise a maximum latency, a maximum time to inference, a maximum memory capacity, a maximum power, or a device constraint.

8. The method of claim 1, wherein deploying the selected ANN on the inference device comprises loading the selected ANN into at least one memory of the inference device.

9. The method of claim 8, wherein the memory into which the selected ANN is loaded is determined based on the profile of the selected ANN.

10. A method for generating an artificial neural network (ANN), the method comprising:
inputting specifications of a target inference device to an ANN generation device;
generating candidate ANNs, by the ANN generation device, based on the specifications;
generating trained ANNs, by the ANN generation device, by training the candidate ANNs to perform an inference task;
generating profiles of the trained ANNs, wherein the profiles indicate characteristics of the trained ANNs;
storing the profiles to be queried based on the requirements and to return a profile of one of the trained ANNs having characteristics satisfying requirements of an application, for deployment on a target inference device.

11. The method of claim 10, wherein the specifications of the target inference device comprise the architecture, components, bit width, device types, memory structures, memory types, or memory capacity of the target inference device.

12. The method of claim 10, wherein the inference task comprises image recognition.

13. The method of claim 10, wherein the characteristics of the trained ANNs comprise a memory capacity requirement, inference time, latency, accuracy, number of layers, type of layer, type of activation function, or ANN topology.

14. The method of claim 10, wherein the requirements of the application comprise a maximum latency, a maximum time to inference, a maximum memory capacity, a maximum power, or a device constraint.

15. The method of claim 10, wherein deploying the selected ANN on the inference device comprises loading the selected ANN into at least one memory of the inference device.

16. The method of claim 10, wherein the memory into which the selected ANN is loaded is determined based on the profile of the selected ANN.

17. A method for deploying an artificial neural network (ANN), the method comprising:
querying stored profiles, based on requirements of an application, to select an ANN, the profiles reflecting characteristics of a plurality of ANNs trained to perform an inference task on an inference device conforming to specifications of a target inference device; and
deploying the selected ANN on an inference device conforming to the target inference device specifications.

18. The method of claim 17, wherein the specifications of the target inference device comprise the architecture, components, bit width, device types, memory structures, memory types, or memory capacity of the target inference device.

19. The method of claim 17, further comprising:
communicating input data to the deployed ANN from the application;
generating an output using the deployed ANN; and
communicating the output data to the application.

20. The method of claim 17, further comprising receiving, in response to querying the stored profiles, an indication of one or more ANNs having a stored profile that satisfies the requirement.

21. The method of claim 17, wherein the application provides data to the deployed ANN and receives an inference from the deployed ANN based on the data.

22. The method of claim 17, wherein the requirements of the application comprise a maximum latency, a maximum time to inference, a maximum memory capacity, a maximum power, or a device constraint.

23. The method of claim 17, wherein deploying the selected ANN on the inference device comprises loading the selected ANN into at least one memory of the inference device.

24. The method of claim 23, wherein the memory into which the selected ANN is loaded is determined based on the profile of the selected ANN.

25. A device for generating an artificial neural network (ANN), the device comprising:
an input interface configured to input specifications of a target inference device;
processing circuitry configured to generate candidate ANNs based on the specifications;
processing circuitry configured to generate trained ANNs by training the candidate ANNs to perform an inference task;
profiling circuitry configured to generate profiles of the trained ANNs which reflect the characteristics of each trained ANN, and to store the profiles to be queried based on the requirements and to return a profile of one of the trained ANNs having characteristics satisfying requirements of an application, for deployment on a target inference device.

26. The device of claim 25, wherein the specifications of the target inference device comprise the architecture, components, bit width, device types, memory structures, memory types, or memory capacity of the target inference device.

27. The device of claim 25, wherein the characteristics of the trained ANNs comprise a memory capacity requirement, inference time, latency, accuracy, number of layers, type of layer, type of activation function, or ANN topology.

28. The device of claim 25, wherein the requirements of the application comprise a maximum latency, a maximum time to inference, a maximum memory capacity, a maximum power, or a device constraint.

29. A device for deploying an artificial neural network (ANN) to perform an inference task, the device comprising:
an input interface configured to input inference task requirements of an application;
querying circuitry configured to query stored profiles based on the requirements, the profiles reflecting characteristics of ANNs trained to perform an inference task on a target inference device;
the querying circuitry further configured to select an ANN based on the query; and
deployment circuitry configured to deploy the selected ANN on an inference device conforming to specifications of the target inference device.

30. The device of claim 29, wherein the specifications of the target inference device comprise the architecture, components, bit width, device types, memory structures, memory types, or memory capacity of the target inference device.

31. The device of claim 29, wherein querying the stored profiles comprises matching the requirements to characteristics of the trained ANNs.

32. The device of claim 31, wherein the characteristics comprise a memory capacity requirement, inference time, latency, accuracy, number of layers, type of layer, type of activation function, or ANN topology.

33. The device of claim 29, wherein the querying circuitry is configured to receive, in response to the query, an indication of one or more ANNs having a stored profile that satisfies the requirements.

34. The device of claim 29, wherein the application provides data to the deployed ANN and receives an inference from the deployed ANN based on the data.

35. The device of claim 29, wherein the requirements of the application comprise a maximum latency, a maximum time to inference, a maximum memory capacity, a maximum power, or a device constraint.

36. The device of claim 29, wherein deploying the selected ANN on the inference device comprises loading the selected ANN into at least one memory of the inference device.

37. The device of claim 36, wherein the memory into which the selected ANN is loaded is determined based on the profile of the selected ANN.
